(19) United States
(12) Patent Application Publication
(10) Pub. No.: US 2020/0398868 A1
(43) Pub. Date: Dec. 24, 2020

(54) VEHICLE CONTROL SYSTEM, VEHICLE CONTROL METHOD, AND PROGRAM

(71) Applicant: HONDA MOTOR CO., LTD., Minato-ku, Tkyo (JP)

(72) Inventors: Hiroaki Horii, Wako-shi (JP); Tadahiko Kanoh, Wako-shi (JP); Jun Ochida, Wako-shi (JP); Nobuharu Nagaoka, Wako-shi (JP); Hirofumi Kanazaki, Wako-shi (JP); Luwei ` Jia, Wako-shi (JP)

(21) Appl. No.: 16/970,976

(22) PCT Filed: Feb. 21, 2018
(86) PCT No.: PCT/JP2018/006133

§ 371 Date: Aug. 19, 2020

(51) Int. Cl. B60W 60/00; G06K 9/00; B60W 50/14

(52) U.S. Cl. CPC B60W 60/0051; B60W 60/0053; B60W 50/14; G06K 9/00791; B60W 60/0059

(57) ABSTRACT

A vehicle control system (1, 100) includes: a recognizer (120) configured to recognize a surrounding situation of a vehicle; a controller (120, 160) configured to control one or both of steering and a decelerated or accelerated speed of the vehicle and perform driving support of the vehicle based on the surrounding situation recognized by the recognizer; and a mode controller (170) configured to cause the controller to perform first control such that the driving support is ended when the driving support ends in accordance with a first state in the vehicle and to cause the controller to perform second control such that the vehicle is decelerated while reducing a risk and subsequently end the second control when the driving support ends in accordance with a second state in the vehicle in a case in which the controller performs the driving support.

### TECHNICAL FIELD

The present invention relates to a vehicle control system, a vehicle control method, and a program.

### BACKGROUND ART

As disclosed in the related art, a driving support device generates a route for automated driving to a destination and starts automated driving when a destination setter sets a destination, generates a route for automated driving along a road and starts automated driving when the destination setter has not set a destination and a travel intention detector detects that a driver has an intention to continue traveling, and generates a route for automated stopping and starts the automated driving when the destination setter does not set a destination and the travel intention detector detects that the driver has no intention to continue the traveling (for example, see Patent Literature 1).

### CITATION LIST

### Patent Literature

[Patent Literature 1]

PCT International Publication No. WO 2011/158347

### SUMMARY OF INVENTION

### Technical Problem

However, the device according to the related art may not perform control appropriate for a behavior of an occupant of a vehicle.

The present invention is devised in view of such circumstances and an objective of the present invention is to provide a vehicle control system, a vehicle control method, and a program capable of performing control appropriate for a behavior of an occupant of a vehicle.

### Solution to Problem

(1) A vehicle control system includes: a recognizer configured to recognize a surrounding situation of a vehicle; a controller configured to control one or both of steering and a decelerated or accelerated speed of the vehicle and perform driving support of the vehicle based on the surrounding situation recognized by the recognizer; and a mode controller configured to cause the controller to perform first control such that the driving support is ended when the driving support ends in accordance with a first state in the vehicle and to cause the controller to perform second control such that the vehicle is decelerated while reducing a risk and subsequently end the second control when the driving support ends in accordance with a second state in the vehicle in a case in which the controller performs the driving support.

(2) In the vehicle control system according to the aspect (1), when the driving support ends in accordance with the first state in the vehicle and before and after the second control is performed from the second state, the mode controller may cause an outputter to output information prompting an occupant of the vehicle to change driving or information indicating an attention to the driving of the vehicle.

(3) In the vehicle control system according to the aspect (1) or (2), the controller may control the vehicle in a first driving mode or a second driving mode in which a task requested to the occupant of the vehicle is lower or the degree of automated control is higher in control of the vehicle than in the first driving mode in the driving support, may end the driving support quickly without being involved in other control when the driving support ends in the first driving mode, and may perform the first control when the vehicle ends the driving support in accordance with the first state in the second driving mode, and performs the second control when the vehicle ends the driving support in accordance with the second state in the second driving mode.

(4) In the vehicle control system according to any one of the aspects (1) to (3), the controller may end the second control and ends the driving support together when a state of the vehicle becomes stable as a result obtained by performing the second control and it is detected that the occupant of the vehicle performs a predetermined operation.

(5) In the vehicle control system according to any one of the aspects (1) to (4), a condition for ending of the driving support in accordance with the first state in the vehicle may be a condition that a switch related to an operation of the driving support is operated or a condition that an operation related to the driving of the vehicle is performed to a degree equal to or greater than a predetermined degree by the occupant of the vehicle. A condition for ending of the driving support in accordance with the second state in the vehicle may be a condition that a control state of the driving support is lowered to the degree equal to or less than the predetermined degree or vigilance of the driver of the vehicle is lowered to the degree equal to or less than the predetermined degree.

(6) In the vehicle control system according to any one of the aspects (1) to (5), the controller may continue the driving support while applying an operation related to the driving of the vehicle when the operation related to the driving of the vehicle is performed to the degree less than the predetermined degree by the occupant of the vehicle, and may determine that the condition for ending of the driving support in accordance with the first state in the vehicle is established when the operation related to the driving of the vehicle is performed to the degree equal to or greater than the predetermined degree by the occupant of the vehicle. The mode controller may cause to the controller to perform the first control such that the driving support is ended when the condition for ending of the driving support is determined to be established.

(7) A vehicle control system includes: a recognizer configured to recognize a surrounding situation of a vehicle; a controller configured to control one or both of steering and a decelerated or accelerated speed of the vehicle and perform driving support of the vehicle based on the surrounding situation recognized by the recognizer; and a mode controller configured to end the driving support when the controller performs the driving support and an occupant of the vehicle shows an intention to end the driving support when the controller performs the driving support and configured to cause the controller to perform control such that the vehicle is decelerated while reducing a risk and subsequently ending the second control when it is determined that it is necessary to end the driving support due to a cause different from the intention of the occupant of the vehicle to end the driving support.

(8) There is provided a vehicle control method causing an in-vehicle computer to perform: recognizing a surrounding situation of a vehicle; controlling one or both of steering and a decelerated or accelerated speed of the vehicle and performing driving support of the vehicle based on the recognized surrounding situation; and performing first control such that the driving support is ended when the driving support ends in accordance with a first state in the vehicle and performing second control such that the vehicle is decelerated while reducing a risk and subsequently ending the second control when the driving support ends in accordance with a second state in the vehicle in a case in which the controller performs the driving support.

(9) There is provided a program causing an in-vehicle computer to perform: recognizing a surrounding situation of a vehicle; controlling one or both of steering and a decelerated or accelerated speed of the vehicle and performing driving support of the vehicle based on the recognized surrounding situation; and causing the controller to perform first control such that the driving support is ended when the driving support ends in accordance with a first state in the vehicle and causing the controller to perform second control such that the vehicle is decelerated while reducing a risk and subsequently ending the second control when the driving support ends in accordance with a second state in the vehicle in a case in which the controller performs the driving support.

### Advantageous Effects of Invention

According to (1), (5), (7) to (9), it is possible to perform control appropriate for a behavior of an occupant of a vehicle.

According to (2), it is possible to appropriately notify an occupant of information regarding driving of a vehicle.

According to (3), it is possible to perform control appropriate for a driving support mode. For example, it is possible to inhibit excessive reports in the first driving mode.

According to (4), a driving operation can be handed to a driver more reliably based on an operation of the driver when a state of a vehicle becomes stable.

According to (6), it is possible to appropriately control a vehicle in accordance with the degree of operation on driving of a vehicle by an occupant of the vehicle.

### BRIEF DESCRIPTION OF DRAWINGS

FIG. 1 is a diagram showing a configuration of a vehicle system 1 in which a vehicle control system according to an embodiment is used.

FIG. 2 is a functional configuration diagram showing a first controller 120, a second controller 160, and a switching controller 170.

FIG. 3 is a diagram showing a control mode that transitions in response to an instruction of the switching controller 170.

FIG. 4 is a flowchart (part 1) showing a flow of a process performed by an automated driving controller 100.

FIG. 5 is a flowchart (part 2) showing a flow of a process performed by the automated driving controller 100.

FIG. 6 is a diagram showing an example of content of a transition determination process.

FIG. 7 is a flowchart showing an example of a flow of a second process.

FIG. 8 is a flowchart showing an example of a flow of a third process.

FIG. 9 is a diagram showing an example of a functional configuration of a vehicle system 1A according to a second embodiment.

FIG. 10 is a diagram showing an example of a hardware configuration of the automated driving controller 100 (a driving supporter 300) according to an embodiment.

### DESCRIPTION OF EMBODIMENTS

Hereinafter, embodiments of a vehicle control system, a vehicle control method, and a program according to the present invention will be described with reference to the drawings.

### First Embodiment

[Overall Configuration]

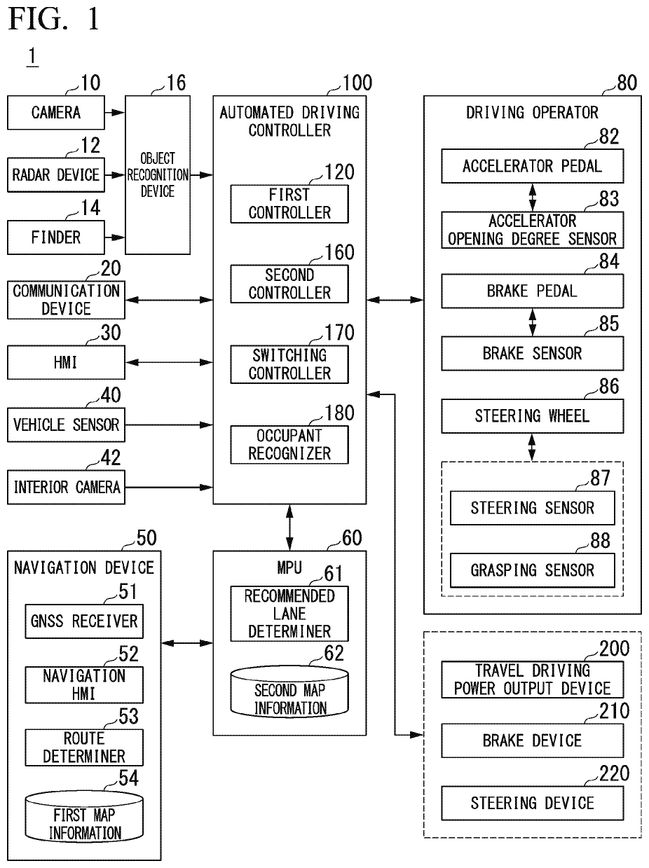

FIG. 1 is a diagram showing a configuration of a vehicle system 1 in which a vehicle control system according to a first embodiment is used. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, or a combination thereof. When the electric motor is included, the electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, an interior camera 42, a navigation device 50, a map positioning unit (MPU) 60, a driving operator 80, an automated driving controller 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely exemplary, part of the configuration may be omitted, and another configuration may be further added.

The camera 10 is, for example, a digital camera that uses a solid-state image sensor such as a charged coupled device (CCD) or a complementary metal oxide semiconductor (CMOS). One camera 10 or a plurality of cameras 10 are mounted on any portion of a vehicle in which the vehicle system 1 is mounted (hereinafter referred to as an own vehicle M). When the camera 10 images a front side, the camera 10 is mounted on an upper portion of a front windshield, a rear surface of a rearview mirror, or the like. For example, the camera 10 repeatedly images the surroundings of the own vehicle M periodically. The camera 10 may be a stereo camera.

The radar device 12 radiates radio waves such as millimeter waves to the surroundings of the own vehicle M and detects radio waves (reflected waves) reflected from an object to detect at least a position (a distance from and an azimuth of) of the object. One radar device 12 or a plurality of radar devices 12 are mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. One finder 14 or a plurality of finders 14 are mounted on any portions of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving controller 100. The object recognition device 16 may output detection results of the camera 10, the radar device 12, and the finder 14 to the automated driving controller 100 without any change, as necessary.

The communication device 20 communicates with another vehicle around the own vehicle M or various server devices via radio base stations using, for example, a cellular network, a Wi-Fi network, Bluetooth (registered trademark), dedicated short range communication (DSRC) or the like.

The HMI 30 presents various types of information to occupants of the own vehicle M and receives input operations by the occupants. The HMI 30 includes, for example, various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M.

The interior camera 42 is, for example, a digital camera in which a solid-state image sensor such as a charged coupled device (CCD) or a complementary metal oxide semiconductor (CMOS) is used. The interior camera 42 is mounted at a position at which an occupant (for example, a driver) of the own vehicle M can be imaged. For example, the interior camera 42 images an imaging target region at a predetermined period and outputs captured images to the automated driving controller 100. The interior camera 42 may be an infrared camera or a stereo camera.

The navigation device 50 includes, for example, a global navigation satellite system (GNSS) receiver 51, a navigation HMI 52, and a route determiner 53 and retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by the occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information. The route on the map determined by the route determiner 53 is output to the MPU 60. The navigation device 50 may perform route guidance using the navigation HMI 52 based on the route on the map determined by the route determiner 53. The navigation device 50 may be realized by, for example, a function of a terminal device such as a smartphone or a tablet terminal possessed by the occupant. The navigation device 50 may transmit a present position and a destination to a navigation server via the communication device 20 to acquire the same route as the route on the map replied from the navigation server.

The MPU 60 functions as, for example, a recommended lane determiner 61 and retains second map information 62 in a storage device such as an HDD or a flash memory. The recommended lane determiner 61 divides the route provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route, a joining spot, or the like, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may access another device using the communication device 20 to be updated frequently.

The driving operator 80 includes, for example, an accelerator pedal 82, a brake pedal 84, a steering wheel 86, a shift lever, a heteromorphic steering wheel, a joystick, and other operators. The driving operator 80 includes an operator sensor. The operator sensor includes, for example, an accelerator opening degree sensor 83, a brake sensor 85, a steering sensor 87, and a grasping sensor 88. The accelerator opening degree sensor 83, the brake sensor 85, the steering sensor 87, and the grasping sensor 88 output detection results to the automated driving controller 100 or the travel driving power output device 200 and one or both of the brake device 210 and the steering device 220.

The accelerator opening degree sensor 83 detects the degree of accelerator opening of the accelerator pedal 82. The brake sensor 85 detects the degree of operation (an operation amount) of the brake pedal 84. The brake sensor 85 detects, for example, a depression amount of the brake pedal based on an amount of change with respect to the brake pedal or a fluid pressure of a master cylinder of the brake device 210. The steering sensor 87 detects the degree of operation (an operation amount) of the steering wheel 86. The steering sensor 87 is provided on, for example, a steering shaft and detects an operation amount of the steering wheel 86 based on a rotational angle of the steering shaft. The steering sensor 87 may detect steering torque and detects the degree of operation of the steering wheel 86 based on the detected steering torque.

The grasping sensor 88 detects whether an occupant of the own vehicle M is grasping the steering wheel 86. The grasping sensor 88 is, for example, an electrostatic capacitance sensor provided along the circumferential direction of the steering wheel 86. The grasping sensor 88 detects a touch of the hands of the occupant with a detection target region as a change in electrostatic capacitance.

The automated driving controller 100 includes, for example, a first controller 120, a second controller 160, a switching controller 170, and an occupant recognizer 180. Each of the first controller 120, the second controller 160, and the switching controller 170 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The details of the automated driving controller 100 will be described below.

The travel driving power output device 200 outputs travel driving power (toque) for causing the own vehicle M to travel to a driving wheel. The travel driving power output device 200 includes, for example, a combination of an internal combustion engine, an electric motor, and a transmission and an electronic control unit (ECU) controlling them. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal 84 included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

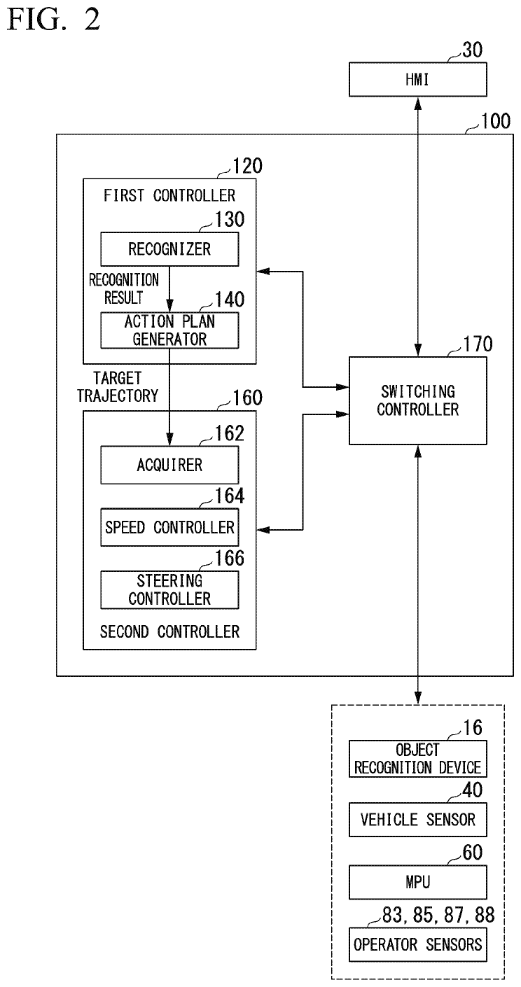

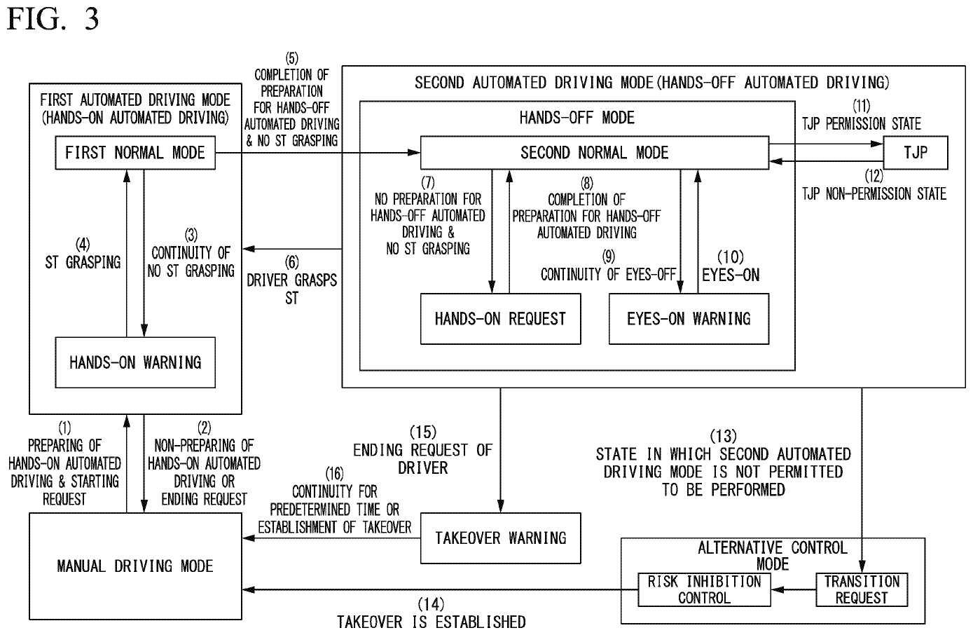

FIG. 2 is a diagram showing a functional configuration of the first controller 120, the second controller 160, and the switching controller 170. In FIG. 2, the occupant recognizer 180 is omitted. The first controller 120 controls the own vehicle M in accordance with a control mode of the vehicle in response to an instruction of the switching controller 170 (the details of which are shown in FIG. 3).

The first controller 120 includes, for example, a recognizer 130 and an action plan generator 140. The first controller 120 realizes, for example, a function by artificial intelligence (AI) and a function by a model given in advance in parallel. For example, a function of “recognizing an intersection” is realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of driving support (driving support) is guaranteed.

The recognizer 130 recognizes states such as a position and a speed, acceleration of an object near the own vehicle M, a distance of an object from the own vehicle M, a relative speed of an object to the own vehicle M, or the like based on information input from the camera 10, the radar device 12, and the finder 14 via the object recognition device 16. For example, the position of the object is recognized as a position on the absolute coordinates in which a representative point (a center of gravity, a center of a driving shaft, or the like) of the own vehicle M is the origin and is used for control. The position of the object may be represented as a representative point such as a center of gravity, a corner, or the like of the object or may be represented as expressed regions. A “state” of an object may include both an acceleration and jerk of the object or an “action state” (for example, whether a vehicle is changing a lane or is attempting to change the lane). The recognizer 130 recognizes the shape of a curve in which the own vehicle M passes from now based on images captured by the camera 10. The recognizer 130 converts the shape of the curve into an actual plane using the images captured by the camera 10 and outputs, for example, 2-dimensional point sequence information or information expressed using a model equivalent to the 2-dimensional point sequence information as information expressing the shape of the curve to the action plan generator 140.

The recognizer 130 recognizes, for example, a lane in which the own vehicle M is traveling (a travel lane). For example, the recognizer 130 recognizes the travel lane by comparing patterns of road mark lines (for example, arrangement of continuous lines and broken lines) obtained from the second map information 62 with patterns of road mark lines around the own vehicle M recognized from images captured by the camera 10. The recognizer 130 may recognize a travel lane by recognizing runway boundaries (road boundaries) including road mark lines or shoulders, curbstones, median strips, and guardrails without being limited to road mark lines. In this recognition, the position of the own vehicle M acquired from the navigation device 50 or a process result by INS may be added. The recognizer 130 recognizes temporary stop lines, obstacles, red signals, toll gates, signs, signboards, and other road events.

The recognizer 130 recognizes a position or a posture of the own vehicle M in the travel lane when the recognizer 130 recognizes the travel lane. For example, the recognizer 130 may recognize a deviation from the middle of a lane of the standard point of the own vehicle M and an angle formed with a line extending along the middle of a lane in the travel direction of the own vehicle M as a relative position and posture of the own vehicle M to the travel lane. Instead of this, the recognizer 130 may recognize a position or the like of the standard point of the own vehicle M with respect to any side end portion (a road mark line or a road boundary) of a travel lane as the relative position of the own vehicle M to the travel lane.

The recognizer 130 may derive recognition precision in the foregoing recognition process and output the recognition precision as recognition precision information to the action plan generator 140. For example, the recognizer 130 generates the recognition precision information for a given period of time based on a frequency at which a road mark line can be recognized.

The action plan generator 140 determines events sequentially performed in automated driving so that the own vehicle M is traveling along a recommended lane determined by the recommended lane determiner 61 and can handle a surrounding situation of the own vehicle M in principle. The events include, for example, a constant speed traveling event in which a vehicle is traveling in the same traveling lane at a constant speed, a following traveling event in which a vehicle follows a front vehicle, an overtaking event in which a vehicle takes over a front vehicle, an avoiding event in which braking and/or steering is performed to avoid approach to an obstacle, a curve traveling event in which a vehicle is traveling in a curve, a passing event in which a vehicle passes a predetermined point such as an intersection, a crosswalk, or a railroad crossing, a lane changing event, a joining event, a branching event, an automated stopping event, and a takeover event in which automated driving ends to switch to manual driving.

The action plan generator 140 generates a target trajectory in which the own vehicle M will travel in future in accordance with an activated event. The target trajectory includes, for example, a speed element. For example, the target trajectory is expressed by arranging spots (trajectory points) at which the own vehicle M will arrive in sequence. The trajectory point is a spot at which the own vehicle M will arrive for each predetermined travel distance (for example, about several [m]) in a distance along a road. Apart from the trajectory points, target acceleration and a target speed are generated as parts of the target trajectory for each of predetermined sampling times (for example, about every fractions of a second). The trajectory point may be a position at which the own vehicle M will arrive at the sampling time for each predetermined sampling time. In this case, information regarding the target acceleration or the target speed is expressed according to an interval between the trajectory points.

The action plan generator 140 generates, for example, a target trajectory based on a recommended lane. The recommended lane is set so that the own vehicle is traveling conveniently along a route to a destination. When the own vehicle arrives in front of a predetermined distance (which may be determined in accordance with a type of event) of a switching spot of the recommended lane, the action plan generator 140 activates a passing event, a lane changing event, a branching event, a joining event, and the like. When it is necessary to avoid an obstacle during execution of each event, an avoidance trajectory is generated.

The second controller 160 controls the travel driving power output device 200, the brake device 210, and the steering device 220 such that the own vehicle M passes along a target trajectory generated by the action plan generator 140 at a scheduled time.

The second controller 160 includes, for example, an acquirer 162, a speed controller 164, and a steering controller 166. The acquirer 162 acquires information regarding a target trajectory (trajectory points) generated by the action plan generator 140 and stores the information in a memory (not shown). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on deviation from the target trajectory in combination.

The switching controller 170 controls the own vehicle M (for example, a control mode of a vehicle) based on a state of the camera 10, the radar device 12, the finder 14, the object recognition device 16, the vehicle sensor 40, the MPU 60, the operation sensor (the accelerator opening degree sensor 83, the brake sensor 85, the steering sensor 87, or the grasping sensor 88), or the automated driving controller 100 or a detection result of the sensor, as shown in FIG. 3.

The occupant recognizer 180 analyzes an image captured by the interior camera 42 and monitors a state of an occupant based on an analysis result. Based on the analysis result of the image, the occupant recognizer 180 determines whether the occupant is in a drowsing state or determines whether the occupant is monitoring the surroundings of the own vehicle M. For example, when a state in which the head of the occupant is oriented in a floor direction of the own vehicle M continues for a predetermined time or when the eyelids of the occupant are continuously closed for a predetermined time or more, it is determined that the occupant is in a drowsing state.

The occupant recognizer 180 determines a region to which the occupant of the vehicle orients his or her visual line based on an analysis result of the image and determines whether the occupant is monitoring the surroundings of the own vehicle M based on a determination result. For example, the occupant recognizer 180 detects a positional relationship between the head and eyes of the occupant and a combination of a standard point and a moving point of the eyes from an image in accordance with a scheme such as template matching. Then, the occupant recognizer 180 drives the direction of a visual line by performing a conversion process of converting an image plane to an actual plane based on a position of the eyes with respect to the head and a position of the moving point with respect to the standard point. For example, when the standard point is an inner corner of the eyes, the moving point is an iris. When the standard point is a cornea reflection region, the moving point is a pupil. The cornea reflection region is a reflection region of infrared light in a cornea when the interior camera 42 or the like radiates infrared light toward the occupant. A processor included in the interior camera may analyze a captured image and determine whether the occupant is monitoring the surroundings of the own vehicle M based on an analysis result.

The occupant recognizer 180 determines whether the driver is grasping the steering wheel 86 or determines the degree of grasping of the steering wheel 86 by the driver based on a detection result of the grasping sensor 88. For example, when an amount of change of electrostatic capacitance detected by the grasping sensor 88 is equal to or greater than a predetermined amount, the occupant recognizer 180 determines that the occupant is grasping the steering wheel 86. When the amount of change of the electrostatic capacitance detected by the grasping sensor 88 is less than the predetermined amount, the occupant recognizer 180 determines that the occupant is not grasping the steering wheel 86. The occupant recognizer 180 may determine whether the driver is grasping the steering wheel 86 or determine the degree of grasping of the steering wheel 86 by the driver based on a detection result of a steering torque detected by the steering sensor 87 instead of the detection result of the grasping sensor 88.

[Overview of Control Mode]

FIG. 3 is a diagram showing control modes that transition in response to an instruction of the switching controller 170. The control modes include, for example, a manual driving mode, a first automated driving mode (a first driving mode), a second automated driving mode (a second driving mode), and an alternative control mode (second control). The manual driving mode is a mode in which a driver of the own vehicle M controls the own vehicle M manually (by operating the accelerator pedal 82, the brake pedal 84, or the steering wheel 86). In a mode in which automated driving is performed, a task requested to the driver of the own vehicle M is higher in the order of the first automated driving mode and the second automated driving mode. The task requested to the driver of the own vehicle M is, for example, grasping of the steering wheel 86, monitoring of the surroundings of the own vehicle M, or the like.

The first automated driving mode (hands-on automated driving mode) is a mode in which automated driving is performed in a state in which an occupant of a vehicle is monitoring the surroundings of the own vehicle M and is grasping the steering wheel 86. The first automated driving mode is, for example, a mode of the automated driving performed on a curve road of a ramp or the like of a highway or a section in which the shape of a road near a tollgate or the like is different from a simple straight line.

The second automated driving mode (a hands-off automated driving mode) is a mode in which the automated driving is performed in a state in which an occupant of the own vehicle M is not grasping the steering wheel 86. The second automated driving mode is a mode of the automated driving in which a task requested to an occupant of the own vehicle M is lower or the degree of automated control is higher in the control of the own vehicle M than in the first automated driving mode. The second automated driving mode is, for example, a mode of the automated driving performed in a section in which the shape of a road of a main lane or the like of a highway is a simple straight line or close to a straight line.

The alternative control mode is a mode performed when the second automated driving mode to be described below is not permitted to be performed and is a mode in which a function of the own vehicle M is controlled more restrictively than in the first automated driving mode and the second automated driving mode (the details of which will be described later).

[Transition of Control Mode]

(1) In the case of the manual driving mode, the control mode transitions to the first automated driving mode when a request for starting the first automated driving mode has been made in a state in which preparation for the first automated driving mode is completed. The state in which preparation of the first automated driving mode is completed is, for example, a state in which a main switch included in the HMI 30 has been operated and an object recognition process starts.

(2) When a driver of the own vehicle M makes a request for ending the first automated driving mode (a request for transition to the manual driving mode) in a state in which the preparation of the first automated driving mode is not completed or in the case of the first automated driving mode, the control mode transitions to the manual driving mode. That is, when the automated driving (driving support) ends in the first automated driving mode, the automated driving ends quickly without being involved in other control. The ending request is, for example, information indicating that an occupant of the own vehicle M operates a predetermined button included in the HMI 30 (information indicating an ending intention).

When the information indicating that the preparation of the first automated driving mode is not completed or the ending request is acquired, the switching controller 170 determines that “the driving support ends in accordance with a first state in the vehicle” and the control mode transitions to the manual driving mode. A state in which the information indicating that the preparation of the first automated driving mode is not completed is output or the state in which the ending request is output is an example of the “first state.” The process of (2) is an example of a process of “causing the controller to perform the first control to end the driving support when the driving support ends in accordance with the first state in the vehicle.”

In (2), the switching controller 170 may cause the HMI 30 to output information prompting an occupant of the vehicle to change driving or information indicating an attention to the driving of the vehicle. In a case in which the first automated driving mode is performed, the switching controller 170 may cause the HMI 30 to output a report requesting the occupant of the vehicle to monitor the surroundings of the own vehicle M when the occupant of the vehicle is not monitoring the surroundings of the own vehicle M.

[First Automated Driving Mode]

The first automated driving mode includes, for example, a first normal mode. The first normal mode is a mode in which the first controller 120 causes the own vehicle M to drive automatedly in a state in which the occupant of the vehicle is monitoring the surroundings of the own vehicle M and the driver of the own vehicle M is grasping the steering wheel 86.

(3) In the first normal mode of the first automated driving mode, the switching controller 170 causes the HMI 30 to output a hands-on warning (a report requesting the driver to grasp the steering wheel 86), when the driver of the own vehicle M does not continue to grasp the steering wheel (ST) 86 for a predetermined time.

(4) When the hands-on warning is performed and the driver of the own vehicle M grasps the steering wheel 86, the output of the hands-on warning is stopped and the control mode transitions to the first normal mode.

In the first automated driving mode, when the driver of the vehicle performs an operation related to the driving of the vehicle (an operation on at least one of the accelerator pedal 82, the brake pedal 84, or the steering wheel 86) to the degree equal to or greater than a predetermined degree, the switching controller 170 may determine that the ending request of the driver is output (an ending condition of the driving support is established).

In the first normal mode, when the occupant of the vehicle performs the operation related to the driving of the vehicle to the degree less than the predetermined degree, the first controller 120 may continue the automated driving while applying the operation related to the driving of the own vehicle M. For example, when the accelerator pedal 82 is operated, the vehicle is accelerated, and the brake pedal 84 is operated, the first controller 120 decelerates the vehicle. For example, when the steering wheel 86 is operated to change the lane of the own vehicle M, the first controller 120 causes the vehicle to its lane to change to a lane located in a direction in which the steering wheel 86 is operated.

(5) In the first normal mode, when the automated driving controller 100 notifies the driver that the preparation of the second automated driving mode is completed and subsequently an operation amount of the steering wheel 86 grasped by the driver is less than a threshold, the control mode transitions to the second automated driving mode. The completion of the preparation of the second automated driving mode is, for example, a state in which each unit of the own vehicle M is controlled in a state in which a process can be performed to travel in the second automated driving mode. (6) Win the second automated driving mode, when the operation amount of the driver grasping the steering wheel 86 is equal to or greater than the threshold, the control mode transitions to the first automated driving mode.

[Second Automated Driving Mode]

The second automated driving mode includes, for example, a hands-off mode and a traffic jam pilot (hereinafter referred to as TJP) mode. The hands-off mode is a mode of the automated driving performed in a state in which the driver of the own vehicle M is monitoring the surroundings of the own vehicle M.

The hands-off mode is, for example, a second normal mode. The second normal mode is a mode of the automated driving performed in a state in which the driver of the own vehicle M is not grasping the steering wheel 86 and is monitoring the surroundings of the own vehicle M.

The TJP mode is a mode of the automated driving performed even in a state in which it is not necessary for the driver of the own vehicle M to grasp the steering wheel 86 and the driver of the own vehicle M is not monitoring the surroundings of the own vehicle M. The TJP mode is, for example, a control state in which the own vehicle M follows a nearby vehicle (a front vehicle) traveling in front of the own vehicle M within the same lane as the lane in which the own vehicle M travels at a predetermined speed (for example, 60 [km/h]) or less. The TJP mode may be triggered when the speed of the own vehicle M is equal to or less than a predetermined speed and an inter-vehicle distance from the front vehicle is within in a predetermined distance, or may be triggered when the HMI 30 receives an operation from an occupant. For example, information indicating whether the TJP mode is performed or the control mode can transition to the TJP mode is displayed on a display of the HMI 30. The TJP mode is a mode of the automated driving in which a task requested to an occupant of the own vehicle M is lower or the degree of automated control is higher in the control of the own vehicle M than in the second normal mode. In the case of a TJP permission state, even when the driver is grasping the steering wheel 86 in a state in which an input of a steering torque is small, the control mode transitions to the TJP mode and further even when the driver continues to grasp the steering wheel 86 after the transition, the TJP mode continues.

(7) In the second normal mode of the second automated driving mode, when the second normal mode is not prepared (for example, in a section in which the preparation for the second automated driving mode is not completed or the second automated driving mode cannot be performed) and the driver of the own vehicle M does not continue to grasp the steering wheel 86 for a predetermined time, the switching controller 170 causes the HMI 30 to output a hands-on request. The hands-request is used to request the driver of the own vehicle M to grasp the steering wheel 86. (8) When the hands-on request is output, the second normal mode is prepared, and the steering wheel 86 is not grasped, the control mode transitions to the second normal mode.

(9) When eyes-off is continuously detected for a predetermined time in the second normal mode, the switching controller 170 causes the HMI 30 to output an eyes-on warning (a report requesting the occupant of the own vehicle M to monitor the surroundings of the own vehicle M). The eyes-off is a state in which the driver of the own vehicle M is not monitoring the surroundings of the own vehicle M. The eyes-on is a state in which the driver of the own vehicle M is monitoring the surroundings of the own vehicle M. The monitoring means, for example, that a visual line is oriented in a traveling direction of the own vehicle M and to the surroundings of the own vehicle M. (10) When an eyes-on warning is output and the driver of the own vehicle M is monitoring the surroundings of the own vehicle M, the control mode transitions to the second normal mode.

(11) In the second normal mode, when the own vehicle M is in the TJP permission state, the control mode transitions to the TJP mode. The TJP permission state is, for example, a state in which the own vehicle M can be controlled in the TJP mode. (12) In the TJP mode, when the own vehicle M is in a TJP non-permission state, the control mode transitions to the second normal mode. The TJP non-permission state is a state in which the own vehicle M cannot be controlled in the TJP mode.

The second automated driving mode further transitions to the alternative control mode in addition to the case of transition to the first automated driving mode, as described above. (13) In the second automated driving mode, the control mode transitions to the alternative control mode in a state in which the second automated driving mode is not permitted to be performed (when the switching controller 170 determines that it is necessary to end the driving support due to a cause different from an intention to end the driving support). That is, when the second automated driving mode is not permitted to be performed, the switching controller 170 determines that “the driving support ends in accordance with a second state in the vehicle” and causes the control mode to transition to the alternative control mode. The state in which the second automated driving mode is not permitted to be performed is an example of the “second state.”

The state in which the second automated driving mode is not permitted to be performed is, for example, a state in which vigilance of the driver of the own vehicle M is lowered to a predetermined degree or less or a predetermined state of the vehicle system 1. The state in which the vigilance of the driver of the own vehicle M is lowered to the predetermined degree or less is, for example, a state in which the driver of the own vehicle M does not perform a predetermined behavior (for example, a state in which the driver is not monitoring the surroundings of the own vehicle M or a state in which a visual line is not oriented in the traveling direction and to the surroundings of the vehicle), a state in which an occupant is drowsing, or a state in which an occupant is likely to sleep. The predetermined state (a state in which a control state of the driving support is lowered) is, for example, a case in which a predetermined signal or an output value is output from a device or a functional unit related to the automated driving. The predetermined signal is a signal different from a signal output at the time of automated driving (for example, a signal indicating inconvenience or abnormality).

For example, when the second automated driving is not permitted to be performed, the switching controller 170 outputs a request for transitioning the control mode to the first controller 120 and the first controller 120 performs risk inhibition control. The risk inhibition control is control in which the own vehicle M is stopped at a predetermined position (for example, a parking space, a shoulder, or the like) by decelerating the own vehicle M while reducing a risk.

(14) When the state of the own vehicle M becomes stable (decelerated or stopped) as a result of the risk inhibition control of the alternative control mode and it is detected that the occupant of the own vehicle M performs a predetermined operation, the risk inhibition control ends and the automated driving ends. For example, when the own vehicle M stops and subsequently takeover is established (the occupant performs the predetermined operation), the control mode transitions to the manual driving mode. The takeover is a state in which the driver can perform manual driving. For example, when the driver of the own vehicle M operates at least one of the accelerator pedal 82, the brake pedal 84, and the steering wheel 86 to the degree equal to or greater than the predetermined degree, the switching controller 170 determines that the takeover is established. The operation performed to the degree equal to or greater than the predetermined degree is, for example, rotation of the steering wheel 86 to the degree equal to or greater than the predetermined degree. Before and after the risk inhibition control, the switching controller 170 causes the HMI 30 to output the information prompting the occupant of the vehicle to change driving or the information indicating an attention to the driving of the vehicle.

(15) In the second automated driving mode, when an ending request of the driver (information indicating an ending intention) is output, the switching controller 170 causes the HMI 30 to output a takeover warning (a report prompting the driver of the own vehicle M to perform the manual driving). That is, when the ending request is acquired, the switching controller 170 determines for ending of the driving support in accordance with the first state” and outputs a takeover warning mode. The state in which the ending request is output is an example of the “first state.” For example, when the driver performs a predetermined operation on a predetermined button included in the HMI 30, the ending request of the driver is output.

When the driver of the vehicle performs the operation (an operation on at least one of the accelerator pedal 82, the brake pedal 84, and the steering wheel 86) on the driving of the vehicle to the degree equal to or greater than the predetermined degree, the switching controller 170 may determine that the ending request of the driver is output (an ending condition of the driving support is established).

In the second automated driving mode, when the occupant of the vehicle performs an operation on the driving of the vehicle to the degree less than the predetermined degree, the automated driving may continue while applying the operation on the driving of the own vehicle M. For example, the first controller 120 accelerates the vehicle when the accelerator pedal 82 is operated, or decelerates the vehicle when the brake pedal 84 is operated. For example, when the steering wheel 86 is operated by an operation amount equal to or greater than a predetermined operation amount, the first controller 120 changes the lane to a lane located in a direction in which the steering wheel 86 is operated.

(16) When the takeover warning continues to be output for a predetermined time or the takeover is established, the control mode transitions to the manual driving mode.

As described above, the switching controller 170 can perform control appropriate for a behavior of the occupant of the own vehicle M by setting the control mode in accordance with the behavior of the occupant of the own vehicle M.

In the above-described embodiment, when the first automated driving mode is not permitted to be performed in the first automated driving mode (the switching controller 170 determines that it is necessary to end the driving support due to a cause different from an intention to end the driving support), the switching controller 170 may set the control mode to the alternative control mode (the second control). The state in which the first automated driving mode is not permitted to be performed is, for example, a state in which vigilance of the driver of the own vehicle M is lowered to the degree equal to or less than a predetermined degree or a predetermined state of the vehicle system 1.

The state in which the vigilance of the driver of the own vehicle M is lowered to the degree equal to or greater than the predetermined degree is, for example, a state in which a behavior requested to the driver of the own vehicle M (for example, a behavior of grasping the steering wheel 86, a behavior of monitoring the surroundings of the own vehicle M, a behavior of orienting a visual line in the traveling direction or to the surroundings of the own vehicle M, or the like) is not performed or a state in which the degree of grasping of the steering wheel 86 is lowered to the degree equal to or less than a predetermined degree. The predetermined state (a state in which a control state of the driving support is lowered to the degree equal to or less than a predetermined state) is, for example, a case in which a predetermined signal or a predetermined output value is output from a device or a functional unit related to the automated driving of the first automated driving mode. The predetermined signal is a signal (for example, a signal indicating inconvenience or abnormality) different from a signal output at the time of the automated driving of the first automated driving mode.

[Flowchart (Part 1)]

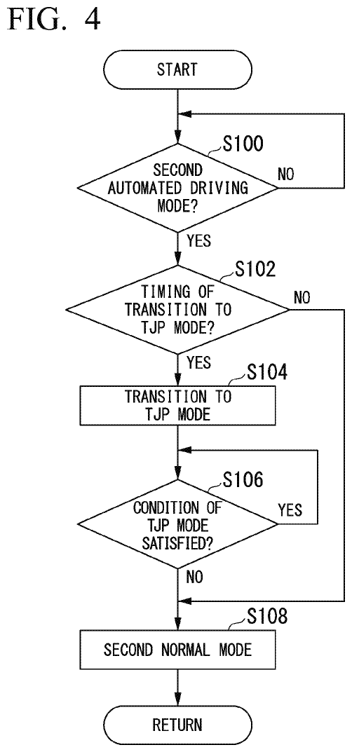

FIG. 4 is a flowchart (part 1) showing a flow of a process performed by the automated driving controller 100. The process of the flowchart is an example of a process when or after the second automated driving mode is performed.

First, the switching controller 170 determines whether the control mode transitions from the first automated driving mode to the second automated driving mode (the second normal mode) (step S100). When the control mode transitions to the second automated driving mode, the switching controller 170 determines whether a timing is a timing at which the control mode transitions from the second normal mode to the TJP mode (step S102).

When the timing is the timing at which the control mode transitions to the TJP mode, the switching controller 170 causes the control mode to transition from the second normal mode to the TJP mode (step S104). When the control mode transitions to the TJP mode, the switching controller 170 determines whether a condition of the TJP mode is satisfied (step S106). While the condition of the TJP mode is satisfied, the TJP mode is maintained.

When the timing is not the timing at which the control mode transitions to the TJP mode or when the condition of the TJP mode is not satisfied in step S106, the switching controller 170 causes the first controller 120 to perform the automated driving in the second normal mode (step S108). Then, the process of one routine of the flowchart ends.

[Flowchart (Part 2)]

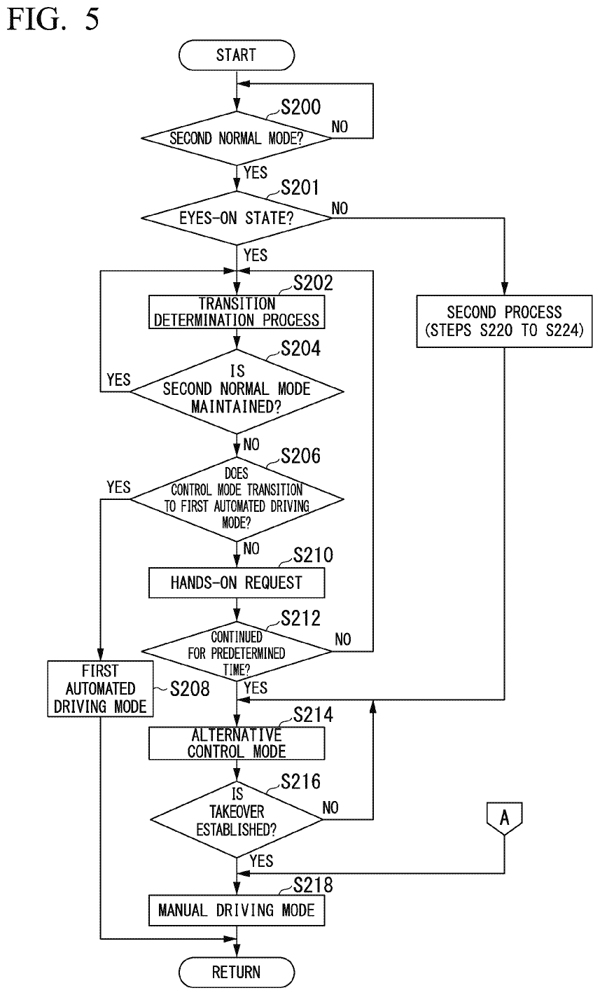

FIG. 5 is a flowchart (part 2) showing a flow of a process performed by the automated driving controller 100. For example, the process may be performed in parallel to the process of one routine of the flowchart of FIG. 4.

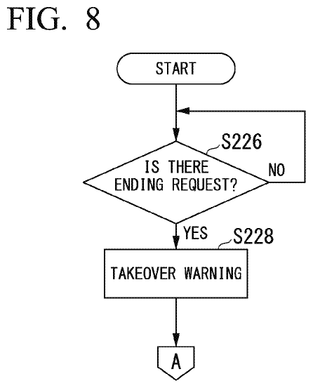

First, the switching controller 170 determines whether the control mode transitions from the first automated driving mode to the second normal mode of the second automated driving mode (step S200). When the control mode is the second normal mode, the switching controller 170 determines whether the occupant is in the eyes-on state (step S201). When the occupant is in the eyes-on state, the first process of step S212 is performed from step S202. When the occupant is not in the eyes-on state, the second process of step S224 is performed from step S220. When the control mode is the second normal mode in step S200, the third process from step S226 to step S228 shown in FIG. 8 to be described below are performed in parallel to another process. Hereinafter, each process will be described.

[First Process]

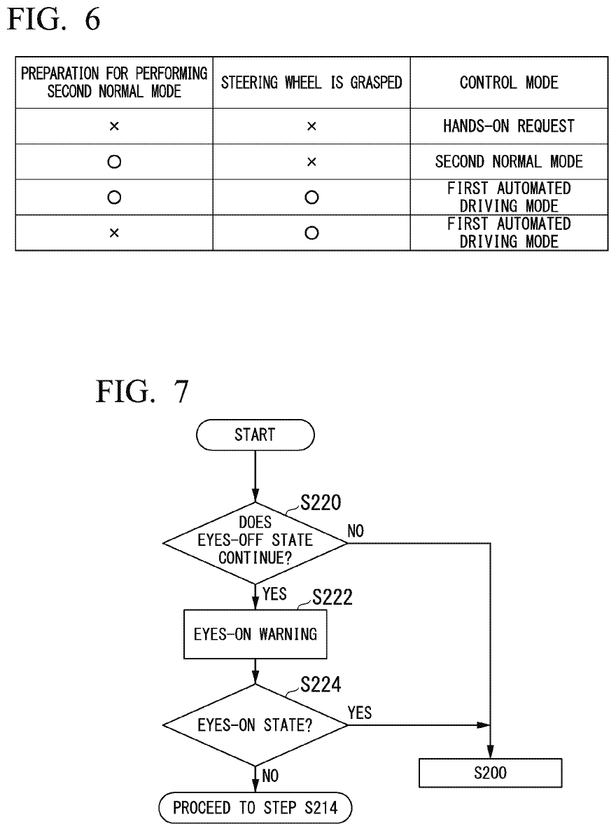

When the control mode is the second normal mode and the occupant is in the eyes-on state, the switching controller 170 performs a transition determination process (step S202). FIG. 6 is a diagram showing an example of content of the transition determination process. Based on a determination result of whether the second normal mode is prepared to be performed and a determination result of whether the steering wheel 86 is grasped, the switching controller 170 determines the control mode which will be performed by the first controller 120.

When the preparation for performing the second normal mode is not completed and the steering wheel 86 is not grasped, the switching controller 170 causes the HMI 30 to output a hands-on request. When the preparation for performing the second normal mode is completed and the steering wheel 86 is not grasped, the second normal mode is maintained as the control mode.

When the preparation for performing the second normal mode is completed or the preparation for performing the second normal mode is not completed and the steering wheel 86 is grasped, the control mode transitions to the first automated driving mode.

FIG. 5 is referred to back for description. The switching controller 170 determines whether the second normal mode is maintained (step S204). When it is determined in the process of step S204 that the second normal mode is maintained, the second normal mode is maintained and the process returns to step S202.

The switching controller 170 determines whether the control mode transitions to the first automated driving mode (step S206). When it is determined in the process of step S206 that the control mode transitions to the first automated riving mode, the control mode is set to the first automated driving mode (step S208). When the switching controller 170 determines in the process of step S206 that the control mode does not transition to the first automated driving mode, the switching controller 170 causes the HMI 30 to output a hands-on request (step S210).

The switching controller 170 determines whether the hands-on request continues to be output for a predetermined time (step S212). When the hands-on request does not continue for the predetermined time, the process returns to step S202.

When the hands-on request continues to be output for the predetermined time, the switching controller 170 sets the control mode to the alternative control mode (step S214). Subsequently, the switching controller 170 determines whether the takeover is established (step S216). When the takeover is not established, the process returns to step S214. When the takeover is established, the switching controller 170 sets the control mode to the manual driving mode (step S218).

[Second Process]

FIG. 7 is a flowchart showing an example of a flow of a second process. When the control mode is the second normal mode and the occupant is not the eyes-on state (an eyes-off state), the switching controller 170 determines whether the eyes-off state continues (step S220). When the eyes-off state does not continue, the process proceeds to step S200. When the eyes-off state continues, the switching controller 170 causes the HMI 30 to output an eyes-on warning (step S222). Subsequently, the switching controller 170 determines whether the occupant is in the eyes-on state (step S224). When it is determined that the occupant is in the eyes-on state, the process proceeds to step S200. When it is determined that the occupant is not in the eyes-on state, the process proceeds to step S214.

[Third Process]

FIG. 8 is a flowchart showing an example of a flow of the third process. When the control mode is the second normal mode, the switching controller 170 determines whether there is an ending request (step S226). When it is determined that there is the ending request, the switching controller 170 causes the HMI 30 to output a takeover warning (step S228) and the process proceeds to step S218. Then, the process of one routine of the flowchart ends. Through the above-described processes, control appropriate for a behavior of the occupant of the own vehicle M is performed.

As described above in the above-described example, the process of determining whether the occupant is in the eyes-on state is performed in step S201, but the determination process may be omitted. In this case, when it is determined in step S200 that the control mode is the second normal mode, the first to third processes are performed in parallel.

According to the above-described first embodiment, the automated driving controller 100 performs the automated driving (the driving support) of the own vehicle M by controlling one or both of steering and an accelerated or decelerated or accelerated speed of the own vehicle M based on a surrounding situation recognized by the recognizer 130. When the automated driving is performed and the driving support ends in accordance with the first state in the own vehicle M, the first control is performed to end the driving support. When the driving support ends in accordance with the second state in the own vehicle M, the second control is performed to decelerate the own vehicle M while reducing a risk and the second control is subsequently ended. In this way, it is possible to perform control appropriate for a behavior of the occupant of the vehicle.

### Second Embodiment

Hereinafter, a second embodiment will be described. In the first embodiment, as described above, the own vehicle M performs the automated driving (the driving support). In the second embodiment, the own vehicle M performs driving support of the own vehicle M different from the automated driving of the first embodiment. Hereinafter, differences from the first embodiment will be mainly described.

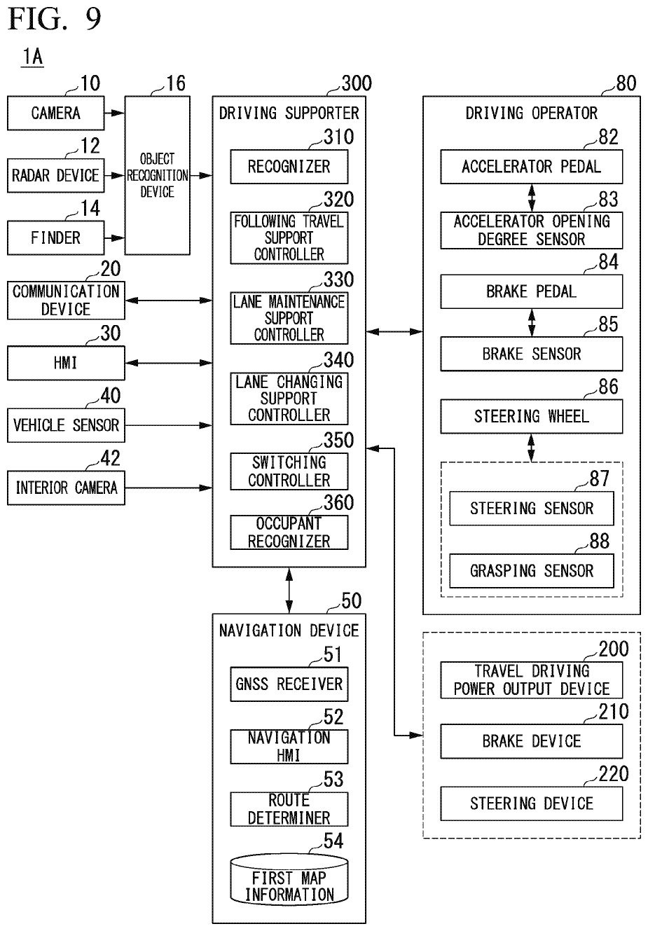

FIG. 9 is a diagram showing an example of a functional configuration of a vehicle system 1A according to the second embodiment. The vehicle system 1A includes, for example, a driving supporter 300 instead of the automated driving controller 100. In the vehicle system 1A, the MPU 60 will be omitted.

The driving supporter 300 includes, for example, a recognizer 310, a following travel support controller 320, a lane maintaining support controller 330, a lane changing support controller 340, a switching controller 350, and an occupant recognizer 360. The functions of the recognizer 310, the switching controller 350, and the occupant recognizer 360 which are the same as those of the recognizer 130, the switching controller 170, and the occupant recognizer 180, and description of the occupant recognizer 180 will be omitted.

Control of one of following travel support control performed by the following travel support controller 320, lane maintaining support control performed by the lane maintaining support controller 330, and lane changing support control performed by the lane changing support controller 340, as will be described below, or control of combination thereof is an example of “driving support which is performed.” Of the following travel support control, the lane maintaining support control, and the lane changing support control, one or more controls (for example, control for requesting an occupant to grasp the steering wheel 86) may be set to the first driving mode and another control (for example, control for not requesting the occupant to grasp the steering wheel 86 or control for requesting an occupant to grasp the steering wheel 86 and another control different from the first driving mode) may be set to a second driving mode in which a task requested to the occupant of the own vehicle M is lower and the degree of automated control related to the control of the own vehicle M is higher than in the first driving mode.

Within the following travel support control, the lane maintaining support control, or the lane changing support control, the first driving mode and the second driving mode in which a task requested to the occupant of the own vehicle M is lower and the degree of automated control related to the control of the own vehicle M is higher than in the first driving mode may be set. For example, the occupant is requested to grasp the steering wheel 86 (or eyes-on) in the first driving mode of the lane changing support control and the occupant is not requested to grasp the steering wheel 86 (or eyes-on) in the second driving mode of the lane changing support control.

For example, the following travel support controller 320 performs control to follow a nearby vehicle traveling in front in the traveling direction of the own vehicle M recognized by the recognizer 310. For example, the following travel support controller 320 starts the following travel support control using an operation performed on a following travel start switch (not shown) by the occupant as a trigger. For example, the following travel support controller 320 performs speed control of the own vehicle M by controlling the travel driving power output device 200 and the brake device 210 such that the own vehicle M follows a nearby vehicle located within a predetermined distance (for example, about 100 [m]) in front of the own vehicle M (hereinafter referred to as a front vehicle) among nearby vehicles recognized by the recognizer 310. The “following” is, for example, traveling while constantly maintaining a relative distance of the own vehicle M to the front vehicle (an inter-vehicle distance). The following travel support controller 320 may cause the own vehicle M to travel simply at a set speed of the vehicle when the recognizer 310 recognizes no front vehicle.

The lane maintaining support controller 330 controls the steering device 220 such that the own vehicle M maintains its lane in which the own vehicle M is traveling based on the position of the lane (a road mark line) which is recognized by the recognizer 310 and in which the own vehicle M is traveling. For example, the lane maintaining support controller 330 starts the lane maintaining support control using an operation performed on a lane maintaining start switch (not shown) by the occupant as a trigger. For example, the lane maintaining support controller 330 controls steering of the own vehicle M such that the own vehicle M travels in the middle of the traveling lane. For example, the lane maintaining support controller 330 controls the steering device 220 and outputs larger steering power in a direction returned to the position of the middle of the traveling lane as a deviation of the standard point of the own vehicle M from the middle of the traveling lane is larger. Further, when the own vehicle M approaches a road mark line marking the lane, the lane changing support controller 340 may perform inhibition control of deviation from a road by controlling the steering device 220 and controlling steering such that the own vehicle M returns to the middle side of the traveling lane.

The lane changing support controller 340 controls the travel driving power output device 200, the brake device 210, and the steering device 220 and causes the own vehicle M to change its lane to an adjacent lane to which the lane is determined to be changeable even when the occupant does not actively operate the steering wheel 86. For example, the lane changing support controller 340 starts the lane changing support control using an operation performed on a lane changing start switch (not shown) by the occupant as a trigger. For example, when the operation is performed on the lane changing start switch, control of the lane changing support controller 340 is preferred.

The lane changing support controller 340 drives a distance necessary to change the lane of the own vehicle M based on a speed of the own vehicle M and the number of seconds necessary to change the lane. The number of seconds necessary to change the lane is set based on a distance until end of traveling of a target distance in the horizontal direction when it is assumed that a distance of horizontal movement at the time of a change in the lane is substantially constant and the lane is changed at an appropriate speed in the horizontal direction. Based on the derived distance necessary to change the lane, the lane changing support controller 340 sets an end point of the change in the lane to the middle of the traveling lane on the lane of a lane changing destination. For example, the lane changing support controller 340 performs lane changing support control by setting the end point of the change in the lane as a target position.

According to the above-described second embodiment, the driving supporter 300 can perform control appropriate for a behavior of the occupant of the vehicle by performing the driving support, performing the first control to end the driving support when the driving support is performed and the driving support ends in accordance with the first state in the own vehicle M and ending the second control when the driving support ends in accordance with the second state in the own vehicle M and after the second control is performed to decelerate the own vehicle M while reducing a risk.

The functional configurations of some or all of the embodiments may be realized in combination. For example, in the above-described example of FIG. 3, a predetermined driving support mode (for example, the process of the lane maintaining support controller 330) may be performed instead of the first automated driving mode. The first automated driving mode is not limited to the hands-on automated driving and may be a mode in which the degree of driving support is lower than in the second automated driving mode (the second automated driving mode is not limited to the hands-off automated driving and may be a mode in which the degree of driving support is higher than in the first automated driving mode).

According to each of the above-described embodiments, the vehicle control system includes the recognizer 130 configured to recognize a surrounding situation of a vehicle; the first controller 120 (or the driving supporter 300) configured to control one or both of steering and a decelerated or accelerated speed of the vehicle and perform driving support of the vehicle based on the surrounding situation recognized by the recognizer 130; and the switching controller 170 (or the switching controller 350) configured to cause the first controller 120 to perform the first control such that the driving support is ended by the first controller when the driving support ends in accordance with the first state in the vehicle and to cause the first controller 120 to perform the second control such that the vehicle is decelerated while reducing a risk and subsequently end the second control when the driving support ends in accordance with the second state in the vehicle in a case in which the first controller 120 performs the driving support. In this way, it is possible to perform control appropriate for a behavior of the occupant of the vehicle.

[Hardware Configuration]

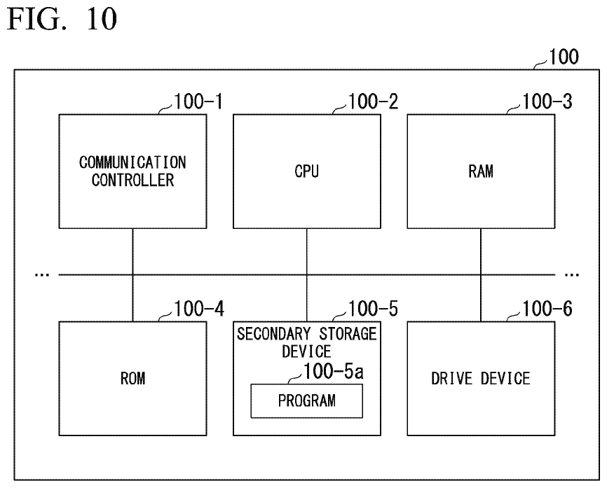

The automated driving controller 100 (or the driving supporter 300 of the vehicle system 1A) according to the above-described embodiments is realized by, for example, a hardware configuration shown in FIG. 10. FIG. 10 is a diagram showing an example of a hardware configuration of the automated driving controller 100 (the driving supporter 300) according to an embodiment.

A controller is configured such that a communication controller 100-1, a CPU 100-2, a RAM 100-3 ROM 100-4, a secondary storage device 100-5 such as a flash memory or an HDD, and a drive device 100-6 are connected to each other via an internal bus or a dedicated communication line. A portable storage medium such as an optical disc is mounted on the drive device 100-6. A program 100-5a stored in the secondary storage device 100-5 is loaded on the RAM 100-3 by a DMA controller (not shown) and is executed by the CPU 100-2 to realize the controller. The program referred to by the CPU 100-2 may be stored in a portable storage medium mounted on the drive device 100-6 or may be downloaded from another device via a network NW.

The above-described embodiments can be expressed as follows:

a vehicle control system including a storage and a hardware processor that executes a program stored in the storage device, the hardware processor executing the program to perform: recognizing a surrounding situation of a vehicle; controlling one or both of steering and a decelerated or accelerated speed of the vehicle and performing driving support of the vehicle based on the recognized surrounding situation; and performing first control such that the driving support is ended when the driving support ends in accordance with a first state in the vehicle and performing second control such that the vehicle is decelerated while reducing a risk and subsequently ending the second control when the driving support ends in accordance with a second state in the vehicle in a case in which the controller performs the driving support.

The embodiments for carrying out the present invention have been described above, but the present invention is not limited to the embodiments. Various modifications and substitutions can be made within the scope of the present invention without departing from the gist of the present invention.

### REFERENCE SIGNS LIST

1, 1A Vehicle system
100 Automated driving controller
120 First controller
130 Recognizer
140 Action plan generator
160 Second controller
162 Acquirer
164 Speed controller
166 Steering controller
170 Switching controller
180 Occupant recognizer
300 Driving supporter
310 Recognizer
320 Following travel support controller
330 Lane maintaining controller
340 Lane maintaining support controller
360 Occupant recognizer

1. A vehicle control system comprising:
a recognizer configured to recognize a surrounding situation of a vehicle;
a controller configured to control one or both of steering and a decelerated or accelerated speed of the vehicle and perform driving support of the vehicle based on the surrounding situation recognized by the recognizer; and
a mode controller configured to cause the controller to perform first control such that the driving support is ended when the driving support ends in accordance with a first state in the vehicle and to cause the controller to perform second control such that the vehicle is decelerated while reducing a risk and subsequently end the second control when the driving support ends in accordance with a second state in the vehicle in a case in which the controller performs the driving support.

2. The vehicle control system according to claim 1, wherein, when the driving support ends in accordance with the first state in the vehicle and before and after the second control is performed from the second state, the mode controller causes an outputter to output information prompting an occupant of the vehicle to change driving or information indicating an attention to the driving of the vehicle.

3. The vehicle control system according to claim 1, wherein the controller:
controls the vehicle in a first driving mode or a second driving mode in which a task requested to the occupant of the vehicle is lower or the degree of automated control is higher in control of the vehicle than in the first driving mode in the driving support,
ends the driving support quickly without being involved in other control when the driving support ends in the first driving mode, and
performs the first control when the vehicle ends the driving support in accordance with the first state in the second driving mode and performs the second control when the vehicle ends the driving support in accordance with the second state in the second driving mode.

4. The vehicle control system according to claim 1, wherein the controller ends the second control and ends the driving support together when a state of the vehicle becomes stable as a result obtained by performing the second control and it is detected that the occupant of the vehicle performs a predetermined operation.

5. The vehicle control system according to claim 1,
wherein a condition for ending of the driving support in accordance with the first state in the vehicle is a condition that a switch related to an operation of the driving support is operated or a condition that an operation related to the driving of the vehicle is performed to a degree equal to or greater than a predetermined degree by the occupant of the vehicle, and
wherein a condition for ending of the driving support in accordance with the second state in the vehicle is a condition that a control state of the driving support is lowered to the degree equal to or less than the predetermined degree or vigilance of the driver of the vehicle is lowered to the degree equal to or less than the predetermined degree.

6. The vehicle control system according to claim 1,
wherein the controller continues the driving support while applying an operation related to the driving of the vehicle when the operation related to the driving of the vehicle is performed to the degree less than the predetermined degree by the occupant of the vehicle and determines that the condition for ending of the driving support in accordance with the first state in the vehicle is established when the operation related to the driving of the vehicle is performed to the degree equal to or greater than the predetermined degree by the occupant of the vehicle, and
wherein the mode controller causes to the controller to perform the first control such that the driving support is ended when the condition for ending of the driving support is determined to be established.

7. A vehicle control system comprising:
a recognizer configured to recognize a surrounding situation of a vehicle;
a controller configured to control one or both of steering and a decelerated or accelerated speed of the vehicle and perform driving support of the vehicle based on the surrounding situation recognized by the recognizer; and
a mode controller configured to end the driving support when the controller performs the driving support and an occupant of the vehicle shows an intention to end the driving support when the controller performs the driving support and configured to cause the controller to perform control such that the vehicle is decelerated while reducing a risk when it is determined that it is necessary to end the driving support due to a cause different from the intention of the occupant of the vehicle to end the driving support.

8. A vehicle control method causing an in-vehicle computer to perform:
recognizing a surrounding situation of a vehicle;
controlling one or both of steering and a decelerated or accelerated speed of the vehicle and performing driving support of the vehicle based on the recognized surrounding situation; and
performing first control such that the driving support is ended when the driving support ends in accordance with a first state in the vehicle and performing second control such that the vehicle is decelerated while reducing a risk and subsequently ending the second control when the driving support ends in accordance with a second state in the vehicle in a case in which the controller performs the driving support.

9. A non-transitory computer-readable storage medium that is configured to store a computer program to be executed by a computer to perform at least:
recognize a surrounding situation of a vehicle;
control one or both of steering and a decelerated or accelerated speed of the vehicle and performing driving support of the vehicle based on the recognized surrounding situation; and
cause the controller to perform first control such that the driving support is ended when the driving support ends in accordance with a first state in the vehicle and causing the controller to perform second control such that the vehicle is decelerated while reducing a risk and subsequently ending the second control when the driving support ends in accordance with a second state in the vehicle in a case in which the controller performs the driving support.
